(19) United States
(12) Patent Application Publication
(10) Pub. No.: US 2012/0130819 A1
(43) Pub. Date: May 24, 2012

(54) METHOD AND SYSTEM FOR PROVIDING CUSTOMIZED CONTENT USING EMOTIONAL PREFERENCE

(75) Inventors: Alex Willcock, West Sussex (GB); Anthony Powell, London (GB); Uladzimir Maroz, London (GB); David Starling, London (GB); Charles Wiles, Surrey (GB)

(73) Assignee: IMAGINI HOLDINGS LIMITED, London (GB)

(21) Appl. No.: 13/264,386

(22) PCT Filed: Apr. 9, 2010
(86) PCT No.: PCT/IB2010/051532

§ 371 Date: Jan. 18, 2012

Related U.S. Application Data
(60) Provisional application No. 61/169,707, filed on Apr. 15, 2009.

(51) Int. Cl. G06Q 30/02; G06F 15/18; G06F 15/16

(52) U.S. Cl. 705/14.66; 705/26.7; 709/203; 706/12

(57) ABSTRACT

A system and method for providing customized content using emotional preference is disclosed. In one embodiment, the system comprises a web analytics server, at least one website server and at least one user device all communicating through a network. The web analytics server collects a user's emotional preference and monitors a user's activity on a website. In one embodiment, the system further comprises an advertisement server that customizes advertisement using the information provided. In another embodiment, the system further comprises a recommendation engine and a product provider server. The recommendation engine recommends products from the product provider server and provides a link such that the user can purchase the product online.

### FIELD OF INVENTION

This invention relates to a method, system, and computer program product for providing customized content to a user through collecting the user's emotional preference and the user's online activity.

### BACKGROUND OF INVENTION

Typical web analytics tools collect information of a user's behavior on a website. Such information helps website publishers and advertisers better understand the website users. The publishers can use the information to improve their website while the advertisers can use the information to improve users' response to a marketing campaign by tailoring the advertisement according to the users' interest. However the information collected may not truly reflect the preferences of the user.

In fact, existing computers only have the capability of recording, analyzing or manipulating factual information that are objective in nature. For example, existing computers are equipped with mouse, keyboard or touchpad to receive the user's hand actions in selecting the specific text or numerals that the user desires, although these hand actions are the results of his ‘considered thought process’. Existing computer systems can not capture and manipulate the subjective mental state such as the user's emotional preferences, or convert them into a machine readable form so that they can be analyzed and stored by computers. Without taking human emotion into consideration, existing computers have a disadvantage in performance compared to human in many applications, including but not limited to Internet-based marketing.

### SUMMARY OF INVENTION

In the light of the foregoing background, it is an object of the present invention to provide an alternate system and method which use technical solutions to extract human emotional preferences into machine readable code so that the machine can manipulate and store such emotional preferences as technical data, and use it to provide customized content for a variety of applications. In different embodiments, the customized content can be advertisements, product recommendations or content recommendations. Accordingly, the present invention, in one aspect, comprises a web analytics server, at least one website server and at least one user device. These subsystems communicate through a network.

In an exemplary embodiment of the present invention, the web analytics server comprises an emotional profiling module, a user activity monitoring module and a website profiling module. The emotional profiling module collects a user's emotional preference through the website server, the user activity monitoring module monitors a user's activity on the website server and the website profiling module generates statistics about users that visit a webpage on the website server. A website publisher can then customize the advertisements, product recommendations or content recommendations according to the statistics obtained.

In another exemplary embodiment, the system further comprises an advertisement server. The advertisement server obtains a user's emotional preference from the web analytic server and customizes the advertisements based on the user's emotional preference.

In another exemplary embodiment, the system further comprises a recommendation engine. The recommendation engine obtains a user's emotional preference from the web analytic server and customized product recommendation or content recommendation based on the user's emotional preference.

In one embodiment, emotional preference of a user is obtained by having the user answering a multimedia survey. A multimedia survey is more fun to do than traditional text-based surveys, and also some of the survey questions can reflect the emotional preference of the user better due to the elimination of a “considered thought” process. Therefore targeted advertisements can be more effective when they take the emotional preference of the user into account.

In another aspect of the present invention, a method is disclosed for providing customized content to a user. The method comprises the steps of assigning an emotional preference to content on a website server, obtaining the emotional preference of the user from a web analytics server, customizing content on the website server and presenting the customized content to the user through a user device. The customization of content is done by comparing the emotional preference of the user with the emotional preference of the content against a predetermined criterion and retrieving contents that satisfy the predetermined criterion in the website as customized content.

In one embodiment, the method further comprises a step of generation an emotional preference to the user by analyzing user response to a multimedia survey presented to the user.

In another embodiment, the obtaining step further allocates a community emotional preference to the user if the user belongs to the community and do not possess an emotional preference.

The advantages of the present invention are that the publishers or advertisers can obtain users' emotional preferences through the use of multimedia survey, user's activity monitoring and analysis of user's community, and utilize users' emotional preferences to target potential customers more effectively. The present invention thus overcomes the technical problem in the art that existing computers are not able to covert the emotional characteristics of a human to a machine-readable language. The emotional reflex of a human which is a type of external technical data can now be technically processed and stored in the computers. By utilizing technical solutions such as transmitting the surveys through the communication network e.g. the Internet, and equipping the user with an the existing computer that is able to display surveys and allows the user to use mouse click to select an image, coupled with the techniques to extract user's emotional code from his responses, the performance of the existing computers are greatly enhanced as they can now analyze not only factual but also emotional information of the user before recommending a decision. In essence, human emotional preferences can thus be machine-processed similar to other external technical data.

### BRIEF DESCRIPTION OF FIGURES

FIG. 1 is a network diagram of the first embodiment of the present invention.

FIG. 2 is the block diagram of the web analytics server.

FIG. 3 shows the major software modules and databases of the emotional profiling module of the web analytic server, and is the data flow diagram of the emotional profiling system.

FIG. 4 is a process flow chart for collection of user data using a code snippet.

FIG. 5 shows the major software modules and databases of the user activity monitoring module of the web analytic server, and is the data flow diagram of the user activity monitoring system.

FIG. 6 is a process flow chart for monitoring of user activity using a web bug

FIG. 7 is the data flow diagram of the website profiling system.

FIG. 8 is the block diagram of the content optimization system.

FIG. 9 is a network diagram of an advertisement optimization system.

FIG. 10 is the data flow diagram of the advertisement optimization system.

FIG. 11 is a process flow chart for customization of advertisements using emotional preference of a user.

FIG. 12 is a specific example of the internal architecture of the hardware and software system of a subsystem as shown in FIG. 1.

FIG. 13 is a network diagram of a product recommendation system.

FIG. 14 is a data flow diagram of the product recommendation system.

FIG. 15 is a process flow chart for the product recommendation system.

### DETAILED DESCRIPTION OF THE PREFERRED EMBODIMENTS

As used herein and in the claims, “comprising” means including the following elements or steps but not excluding others. The term “multimedia object” refers to a multimedia data structure that represents an entity in a computer system. It can be, but is not limited to, a digital image, a video clip, a sound file, or a text-based object. The terms “emotional preference” and “personality code” mean a machine-readable code that codifies all or part of the interests, tastes, needs, desires, goals and preferences that influence a person's choices and decisions. Moreover, the terms “emotional code” and “Visual DNA” are used interchangeably in this document and they all mean emotional preference or personality code obtained through a user taking a multimedia survey. The term “connect” in here means connecting directly or indirectly through electrical means unless otherwise stated.

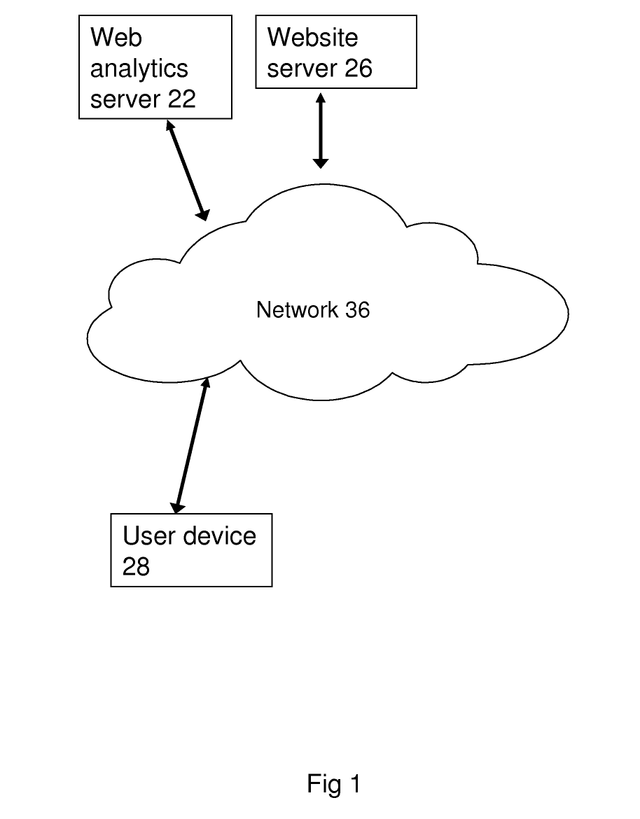

Referring now to FIG. 1, a network diagram of a first embodiment of a system to provide customized content to a user according to the present invention is shown. The system contains multiple subsystems, including a web analytics server 22, at least one website server 26 and at least one user device 28. These subsystems communicate over a network 36. Network 36 can be a local area network (LAN), metropolitan area network (MAN), wide area network (WAN), cellular network, Internet, or a combination thereof. Each of such networks can be implemented using leased lines, optical fiber, wireless technologies, or other networking technologies.

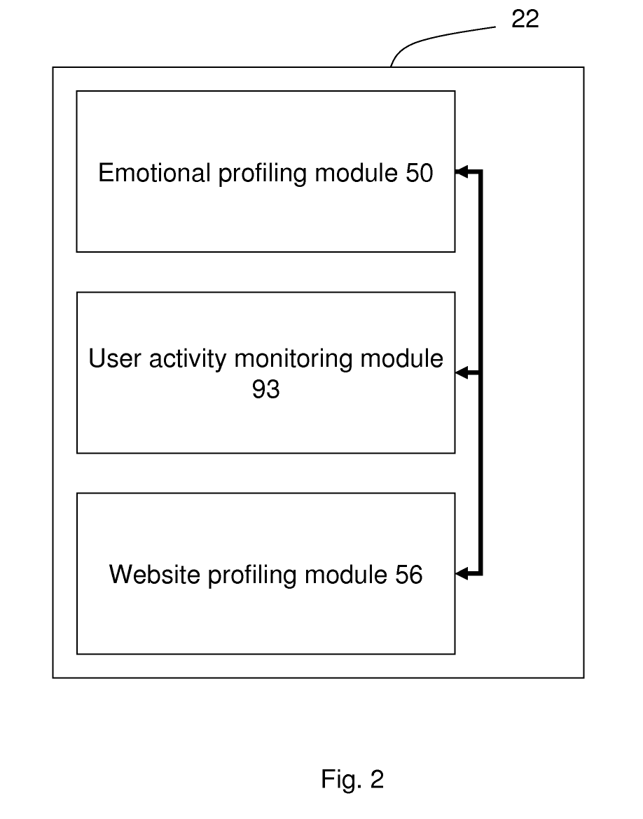

Referring to FIG. 2, an exemplary embodiment of the web analytics server 22 includes several modules including an emotional profiling module 50, a user activity monitoring module 93 and a website profiling module 56. The three modules are all interconnected to each other. These modules may share common components or databases. A detailed description of each module of the web analytics server 22 is provided below when each process is described.

Collection of User Emotional Preference

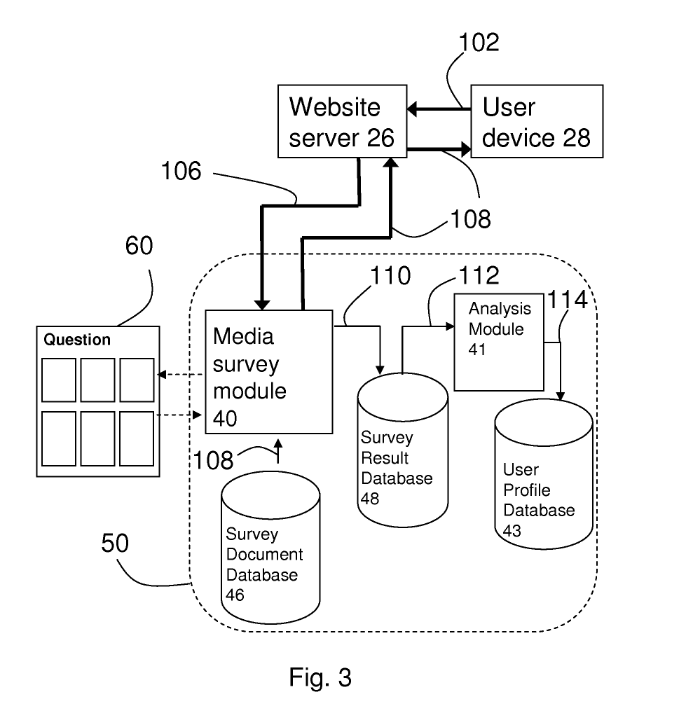

FIG. 3 illustrates one implementation of the emotional profiling module 50. The emotional profiling module 50 includes a media survey module 40, an analysis module 41, and a plurality of databases including a survey result database 48, a user profile database 43, and a survey document database 46. A plurality of multimedia surveys 60 is stored in the survey document database 46. The modules are all interconnected with each other.

Collection of user emotional preference is achieved through the user answering one or more multimedia survey 60. In an implementation of the multimedia survey 60, the survey comprises a plurality of queries, and with each query of the multimedia survey 60, a set of multimedia objects is presented to the user. The user answers the multimedia survey 60 by selecting one or more multimedia object for each query. In an exemplary embodiment, the survey form is displayed on the web browser of the user device 28.

A multimedia survey is more fun for the user to participate, and the data reflects the personality of the user better than regular web tracking. Research has shown that when pure text-based questionnaires are presented to a user, the user will go through a ‘considered thought process’ to read up the multiple choice answers before he selects the one that is applicable to him. However, it is well known that feelings drive a vast majority of human behavior and choices, and how people feel in the test environment is closer to how they would feel and act in real-life. These kinds of inner feelings are information that has important technical significances but are not able to be captured using conventional means. Nonetheless, they can be captured by user's direct emotional response to visual stimuli. Hence a survey comprising a plurality of images or visual objects can capture the emotional reflex of the user that can not be done by conventional text-based questionnaires. Recent experimental results showed that the number of people willing to respond to a multimedia questionnaire is almost three times higher than answering a traditional text-based questionnaire.

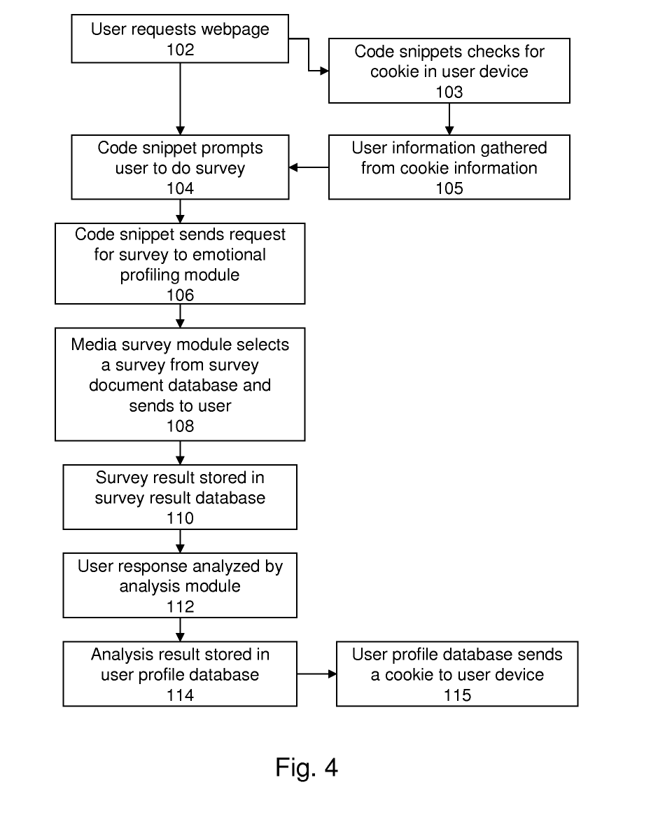

Refer to FIGS. 3 and 4, a flow chart of operation and a data flow diagram for collection of user emotional profile is shown. As a preparation step, a code snippet is provided to the publisher of the website server. The code snippet is a segment of code that retrieves the multimedia survey 60 from the emotional profiling module 50 and also identifies the user. Alternatively, the code snippet can be coded with the content of multimedia survey 60, identify the user and send user's response to the survey back to the survey result database 48. The code snippet is then embedded in the source code of the webpage in the website server 26. In different embodiments, the survey can be placed in the webpage as a banner advertisement or as a flash animation overlay. In some embodiments, the survey can be in various formats such as flash and html or any applicable formats.

When the user requests the webpage through the user device 28 (step 102), the website server 26 delivers the webpage with the code snippet to the user device 28. A user device here is a data processing device such as a desktop computer, a portable computer, a kiosk, a PDA or a mobile phone or the likes. The code snippet then prompts the user to do a survey on the delivered webpage (step 104). When the user decides to do the survey, such as selecting an icon on the webpage that is linked to the code snippet, the code snippet sends the request for the survey to the emotional profiling module 50 (step 106). In one embodiment, the multimedia survey 60 is embedded in the code snippet and the survey is not retrieved from the emotional profiling module 50.

When the code snippet sends the survey request to the emotional profiling module 50, the media survey module 40 selects a multimedia survey 60 from the survey document database 46 and delivers the multimedia survey 60 to the user device 28 through the website server 26 (step 108). In one embodiment, the multimedia survey 60 chosen depends on the code of the code snippet. In another embodiment, the multimedia survey 60 is chosen depends on the past answered survey and query by the user, such that the user will not face a repeated survey or query.

While the user is answering the survey, the user response to each query is stored in the survey result database 48 in real time (step 110). After the user completed the survey, the emotional profiling module 50 invokes the analysis module 41 to analyze the user response stored in the survey result database 48 and assign an emotional code to the user (step 112). In this way, the user's emotional preferences is captured and becomes a form of external technical data that can be further analyzed or processed using the technical solutions mentioned herein. The emotional code, or visual DNA, and the response to each query are then recorded in the user profile database 43, as well as an indicator that the user has now answered this survey (step 114). In one embodiment, each survey has its own unique identity (unique ID) so that it can be distinguished from each other. In another embodiment, each query also has its own unique ID so that even if the same question appears in more than one survey, the user profile database 43 still recognizes that the user has completed that particular question before. After the user has completed a survey, the user profile database 43 sends a cookie file to the user device 28 for future identification (step 115). In one embodiment, the cookie is updated after each completed survey.

Each time before the code snippet prompts the user to answer a multimedia survey 60, it will first check if the cookie is present in the user device 28 (step 103). If the cookie is present, the code snippet can then gather the required information from user profile database 43 through the cookie (step 105). Based on the information, the code snippet may or may not prompt the user to do a survey. When a user with existing profile is prompted to do a survey again, the new emotional code will replace the existing emotional code. In one embodiment, the information stored in the cookie may include a user ID, the emotional code of the user, the unique IDs of the surveys the user has completed before, other relevant information such as the Internet Protocol (IP) address of the user, or any combination of the above. The use of cookies to store the emotional codes and other information is an important technical feature in the present invention since the cookies are computer-readable files which can be stored and transmitted over a computer network such as the Internet. With cookies, user's emotional code can be exchanged between the analytic server and website servers so as to provide tailor-made advertisements according to emotional preferences of a user.

User's data will be used for personalized targeting unless the user has indicated his/her privacy preference otherwise. In one embodiment, the system adopts an opt-in scheme as default. In another embodiment, the system allows the user to opt out. In yet another embodiment the privacy preference is stored in the cookie.

A more detailed explanation of the generation of emotional code from user response is described below. The survey result record has a complex data structure in order to store the multi-facet demographic data and emotional preferences of the user in a multi-dimensional data representative. For example, it may be implemented as a high dimensional matrix, a tree structure or an object-oriented data type. In one implementation, it comprises a vector that records the demographic data of the user, a multi-dimensional matrix that records his emotional preferences, and text fields that record the positive and negative comments from the user. The multi-dimensional matrix may further comprise the choice vector that registers the choices made by the user. It may further comprise the speed vector to record the time it takes for the user to make that choice(s) and the sequential ordering vector that registers the ordering of choices if the user selects more than one choice for a question. As such, the storage of the emotional codes is achieved by a technical solution in which the machine-readable data structure is utilized to allow orderly and efficient storage of the emotional codes.

The analysis module 41 can perform three kinds of analyses that assign users to different emotional code categories. The first type of analysis is category analysis, Category analysis is to analyze the score for each category associated with the images selected by the respondent, and deduce which category this user should be assigned to. In operation, an expert assigns each image a score for each category to which the user can be assigned. In one embodiment, the score is between −10 to 10; and there are four to eight categories chosen by the expert. The category analysis module reads the images stored in the survey result, extract the category scores for those images that the user selects, and tally them up. The combination of tallied scores of each category is the emotional code. The category with the highest total score is recorded in the emotional code as the user's primary category.

In any case, the emotional code and all other relevant information are stored as an emotional profile record for this user in the user profile database 43.

The second analysis method is a statistical technique that performs analysis on survey result.

In operation, an expert chooses two or more axes for each question, in which each axis correspond to a degree of an emotional state that a question is trying to measure. For each question the expert assigns each image a score for each axis. The expert also assigns each category to which a user may be assigned a score for each axis. The statistical analysis module retrieves all the selected images of all survey questions from the survey result database 48. The mathematical distance between the axis scores for each category and the axis scores for the selected images is calculated. The mathematical distance for each category in all the selected images is aggregated. The combination of the aggregated mathematical distance for each category is the emotional code. The category with the shortest aggregated distance will be recorded as the user's primary category. In an exemplary embodiment, there are two axes. The emotional code, and all other relevant information related to this emotional code category are stored in the user profile database 43.

The third analysis method keyword analysis technique. Each image is assigned with a set of keywords. In an exemplary embodiment, a score between −1 and 1 is also associated with the keywords. The keyword analysis module retrieves all the selected images from the survey result database 48, and the sum of scores for each keyword is calculated. The emotional code is the list of keywords associated with the image selected and total score associated with each keyword. The keyword with the highest score will be recorded as user's primary category. The emotional code, and all other relevant information related to this emotional profile category are stored as an emotional profile record in the user profile database 43.

As the emotional code denotes the emotional preference of the user, it is also referred as his Visual DNA. It is advantageous to use an easy-to-remember name or image to denote the emotional code for future references. For example, the names ‘traditionalist’, ‘modernist’ and ‘environmentalist’ can be used. Alternatively, a numeric code can be adopted.

User Activity Monitoring

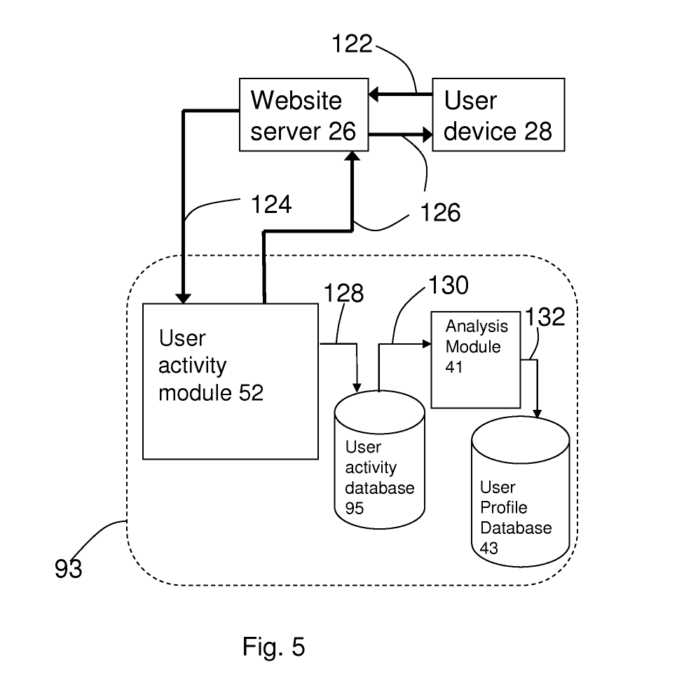

FIG. 5 illustrates one implementation of the user activity monitoring module 93. The user activity monitoring module 93 includes a user activity module 52, a user activity database 95, the analysis module 41 and the user profile database 43. The user activity module 52 is connected to the user device 28. The user activity module 52 is also connected to a user activity database 95. The user activity database 95 is connected to the analysis module 41. The analysis module 41 is connected to the user profile database 43. The analysis module 41 and the user profile database 43 can be the same or different as the one in the emotional profiling system.

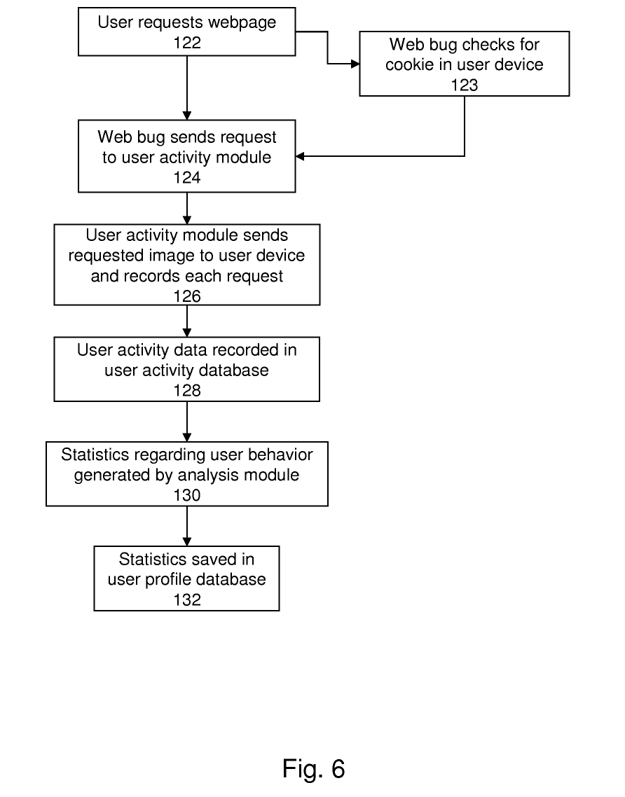

FIGS. 5 and 6 show a flow chart of operation and data flow diagram for monitoring user activity. The user activity module 52 first provides a web bug to the publisher of the website server 26. A web bug is an object that allows tracking of user activity when that user accesses the webpage. In one embodiment, the web bug is in the format of a transparent image having a size of 1×1 pixels (tracking pixel). Website publisher embeds the web bug in web pages that will be tracked.

When the user requests the webpage through a user device 28 (step 122), the website server 26 delivers the webpage with the web bug to the user device 28. The web bug references to the user activity monitoring module 93. When the web bug is loaded, the user device 28 requests the content that the web bug is referencing to from the user activity monitoring module 93 (step 124). The request provides information to the user activity module 52 such as an Internet Protocol (IP) address of user device 28, Universal Resource Location (URL) of the webpage, and the browser of the user device 28 etc. The user activity monitoring module 93 then sends out the requested content such as the transparent image to the user device 28 through the website server 26 (step 126).

The user activity monitoring module 93 tracks a user's activity on the website by recording each of the requests in the user activity database 95 (step 128). Then the user activity data are passed to the analysis module 41 for further analysis, and statistics regarding the user's behavior on the website are generated (step 130). After analysis, the resulting statistics are saved in the user profile database 43 (step 132).

Similar to the case in collection of user emotional preference, the web bug also identifies the user by reading the cookie stored in the user device 28 (step 123). If the user can be identified, the web bug will send the request with the relevant information in the cookie such as the user ID. All user activities will then be stored under that ID.

Various statistics can be gathered or generated from the user's activity data collected through the web bug. In one embodiment, visit time of a page, session duration, page view duration, page view per session and click path etc are all gathered and sent to the user activity monitoring module 93. These statistics are useful to website publishers in evaluating their websites, and useful to the advertisers for evaluating the effectiveness of their advertisements on the websites.

Profiling of Website

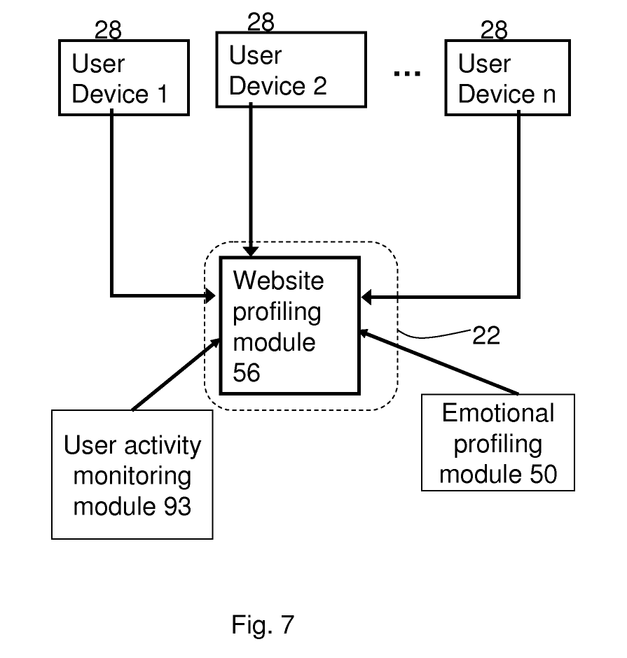

FIG. 7 shows a data flow diagram of an exemplary embodiment of a website profiling system, which is used to provide statistics from website visitors' behavioral and emotional data. It is another aspect of the web analytics system. The embodiment includes the website profiling module 56 of the web analytics server 22. The website profiling module 56 gathers information from a plurality of user devices 28, the emotional profiling module 50 and the user activity monitoring module 93 as described above. In another embodiment, the webpage profiling system can be used for profiling a single webpage.

The website profiling module 56 gathers information from the emotional profiling module 50 and the user activity monitoring module 93 to collect information on the user base. In one embodiment, the user profiling module 56 profiles the users that have visited a certain website or webpage. The information gathered includes but is not limited to the URL address of the website, emotional codes of the users, time of visit and session time of the users, clickstream of the users and demographic information of the users. Through aggregating all the data of the users of a website, the website profiling module 56 generates a website profile, similar to the profile of a user. In one embodiment aggregation of data is done on the users of a webpage, and the website profiling module 56 generates a webpage profile. In different embodiments, the website profile includes raw statistics of the users, or an emotional code of the website, or both. For example, the website profile can be the most common user type that visits the site. In another example, the website profile is a histogram of the user types of users that visit the site. In yet another example, the website profile is a histogram of all answers to all questions in a survey for all users.

The profile provides a view of a site's users in terms of behavioral or emotional factors. Such information is crucial for website publishers to better understand their user base, it helps the website publishers to tailor the website content for their user base and create a self promoting campaign. Further, to maximize the value of webpage space, website publishers can create targeted pitches to attract advertisers to conduct specific advertisement campaigns or recommend specific products; the fine grained demographic and behavioral data provided by the system would be beneficial for making the sales pitches.

The emotional code of the website can be determined using the statistics gathered by the user profiling system. As a typical example, the following method can be used to determine the emotional code of a website. Firstly, data is collected for all visitors of this website. In this example the visitors of the website become the predetermined criteria by which the user community is assembled. The personal emotional codes of these visitors can then be tallied up; and the code with the highest count can be used as the emotional code of the website. In another embodiment, each segment of the emotional code is counted separately.

This is but just one method of determining the emotional code of an object and is referred as the object emotional code. Accordingly, those skilled in the art may devise many other variant schemes to determine the object emotional code and that will generally fall into the scope of this invention. For example, in one embodiment only visitors of the website that stayed in the website for more than a certain period of time are counted towards determining the emotional code of the website.

The website publisher accesses the website profile through a publisher device. A publisher device, similar to the user device 28, is a data processing device such as a desktop computer, a portable computer, a kiosk, a PDA or a mobile phone or the likes. The publisher device sends request for the website profile to the website profiling module 56. The website profiling module 56 then returns the website profile to the publisher device.

Apart from profiling the users by website, there are also many other ways that the users can be profiled. In one embodiment, the users are profiled by their Internet Protocol (IP) address, in which a profile is generated from users within a certain set of IP addresses. For example, a profile can be generated for the user community with an IP address that starts with 100.200. In different embodiments, the sets of IP address can represent the users in a specific geographic location or in a specific organization such as a city, an area within a city, a street, an internet service provider (ISP) or a company etc; such that community emotional profile like city profile, street profile, ISP profile and company profile can be created. It is clear to one skilled in the art that a profile can be generated with any user community as long as the information used to define the user community can be obtained through internet or other methods.

Customization of Content

Based on the results from the modules above, content can be customized to a user to be more appealing to the user. Different contents can be customized, such as website content, advertisements and product recommendations. The three aspects of customization will be described in detail below.

In the examples as described below, content is customized by the user's emotional code. However, it is not the only way to customize content. In one embodiment, customized content is provided according to what images the user has actually clicked onto. While emotional code shows the emotional preference of the user in general, the specific products that the user is interested in can be more effectively shown when the system also take the content of actual images into account. As an example, two users can possess the same emotional code, but they may have different preferences in some aspects such as his/her favorite phone brand. When the two users answer the question “What is your favorite phone brand?” differently, the recommended products to the two users will be different.

In another embodiment, a taxonomy-based customization of content is employed. In this embodiment, each image is tagged with at least one contextual tag. When the user clicks on an image, the user will become associated with the contextual tag. As an example, in the question “What is your favorite phone brand?”, an image could be tagged as “stylish” and another image could be tagged as “value for money”. When the user clicks on the image tagged as “stylish”, the user will be recommended with products that are also tagged as “stylish”.

It is clear to one skilled in the art that the methods described above can be used in combination with one another, so that the content is customized as much as possible for each user.

Customization of Website Content

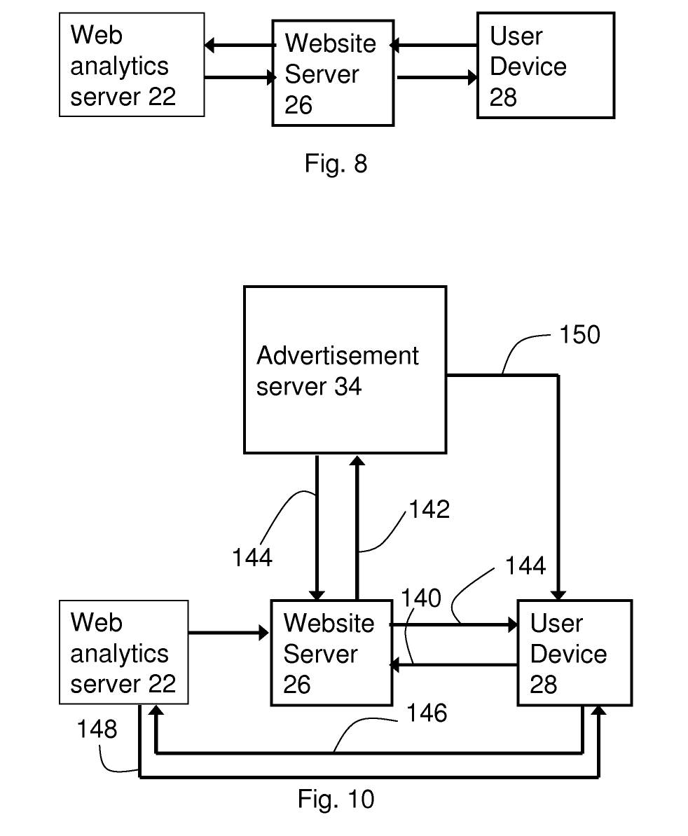

Refer to FIG. 8, it illustrates the content optimization aspect of an embodiment of the present invention. The website server 26 customizes the content of the website according to the profile of the user provided by the web analytics server 22. In one embodiment, if the user does not have a profile, the web analytics server 22 will provide a default profile for this user to the website server 26. The default profile could be the profile of this web site, the city profile, street profile or company profile of the segment that the user is belonged to. With such a profile, the website server 26 can adapt its content to suit the user's profile. For example, for a sports news website, when the website server 26 detects that the user's favorite sports is basketball and least favorite sports is racing through the user's profile on the web analytics server 22, the website layout could be rearranged to include more articles about basketball on the front page and removing articles about racing from the front page or putting an article about basketball as top story. For an online electronics store, when the website server 26 detects a user is interested in a particular style of mobile phones through the user's profile, the website server 26 can showcase the latest mobile phone of that particular style on the webpage. In another embodiment, the webpage will be customized to display recommendation of content such as images, videos, music, or other webpages.

When the user accesses a webpage, the user device 28 sends a request with relevant cookie stored on the device to the website server 26. If the relevant cookie is present, the website server 26 examines the cookie and extracts the unique ID of the user from the cookie. The website server 26 then sends the request for user's profile with the user's unique ID to the web analytics server 22. The web analytics server 22 retrieves the user's profile from the user profile database 43 according to the unique ID included in the request. The web analytics server 22 reviews the privacy preference of the user and sends the part of user profile the website server 26 is authorized to use to the website server 26. In a different embodiment, the web analytics server 22 analysis user's IP address to determine the communities that user is belonged to, the web analytics server 22 retrieves one of the corresponding community emotional profiles and sends the profile to the website server 26.

The website server 26 examines the received profile and determines the emotional preference according to the information delivered by the web analytics server 22. The website server 26 customizes the user requested webpage according to the retrieved emotional preference and sends the customized webpage to the user device 28.

In an exemplary embodiment, the website publisher first determines an emotional code for the webpage on the website server 26. A relevancy between the emotional code of the webpage and the emotional code of the user is then determined. In one embodiment, the relevancy setting is adjustable. The website server 26 then sends out content that have emotional codes that exceeds a certain relevancy. In a different embodiment, the website publisher determines an emotional code for different content of the publisher's interest such as images, videos, music, other webpages not on the website server 26, and a relevancy between the emotional code of the content and the emotional code of the user is then determined, the website server 26 then recommend the content that have emotional codes that exceed a certain relevancy.

As stated above, the relevancy is adjustable, and this affects the diversity of the content delivered to the user. For example, if a user's emotional code shows his favorite sport as basketball, a loose relevancy setting can display contents related to all sports to him, such as football news or baseball goods in addition to basketball related contents. A strict relevancy setting can only display only basketball news and products to the user. In one embodiment, the relevancy is determined by the website publisher. In another embodiment, the relevancy is automatically determined by the website server 26.

Customization of Advertisements

In conventional methods, various techniques is used to improve the effectiveness of online advertisement, such as contextual advertising which displays advertisements according to some keywords in the webpage, and behavioral targeting which displays advertisements according to user's past clickstream, that is where the user has visited before. In the present invention, the website server 26 customizes the content of the website according to the profile of the user provided by the web analytics server 22.

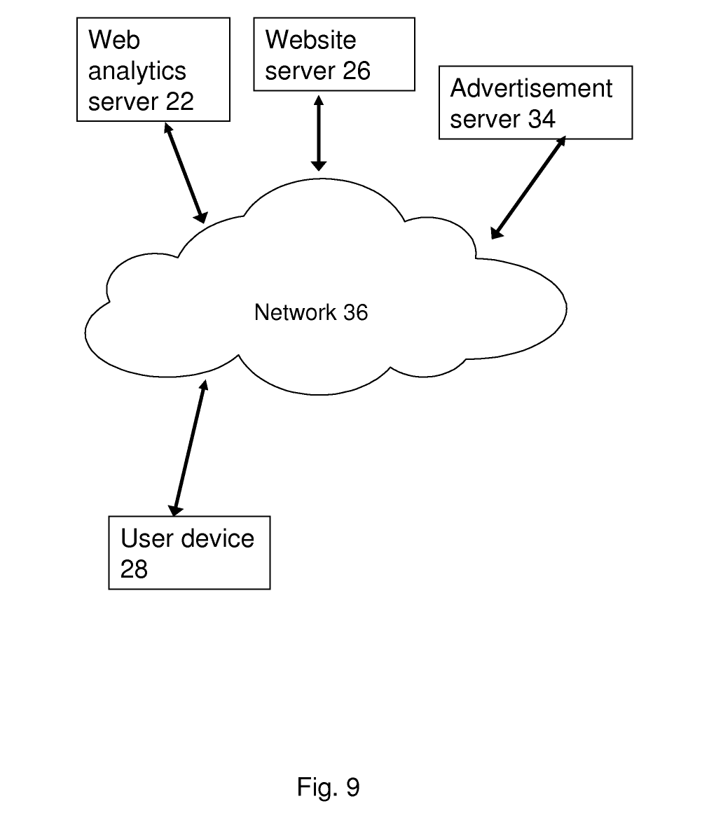

Refer to FIG. 9, it illustrates a network diagram of the advertisement optimization aspect of an embodiment of the present invention. It comprises the web analytics server 22, an advertisement server 34, the website server 26 and the user device 28, communicating through the network 36.

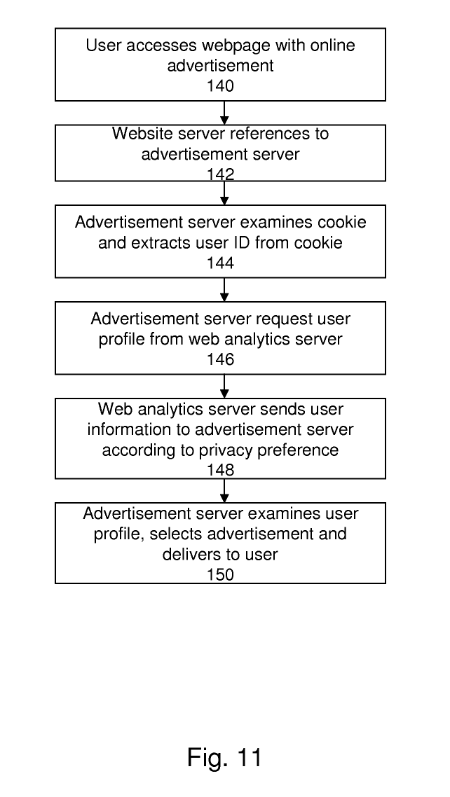

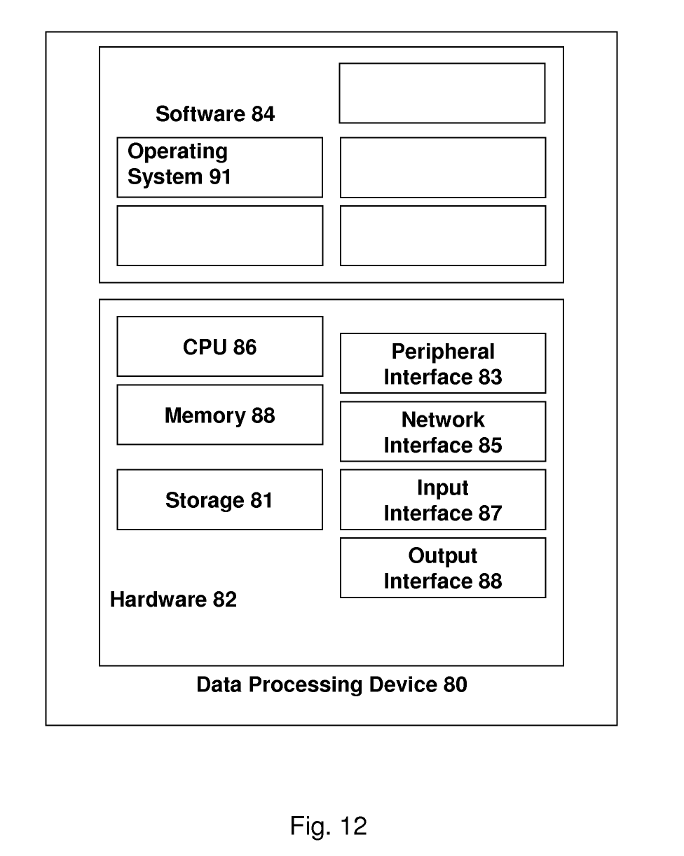

FIGS. 10 and 11 shows a flow chart of operation and a data flow diagram for customization of advertisements using emotional preference. When the user accesses a webpage with online advertisement (step 140), the user device 28 sends a request to the website server 26. The website server 26 sends the requested page without the content of the online advertisement, but with a remote reference to an advertisement server 34, to the user device 28 (step 142). The user device 28 receives the content from the website server 26 and sends a request for the advertisement to the advertisement server 34 according to the remote reference with the relevant cookie (step 144). The advertisement server 34 examines the cookie and extracts the unique ID of the user from the cookie. The advertisement server 34 then sends the request for user's profile with user's unique ID to the web analytics server 22 (step 146). The web analytics server 22 retrieves the user's profile from the user profile database 43 according to the unique ID in the request. The web analytics server 22 reviews the privacy preference of the user, and sends the parts of user profile the advertisement server 34 is authorized to use to the advertisement server 34 (step 148). In a different embodiment, the advertisement server 34 sends the IP address of the user to the web analytics server 22, the web analytics server 22 retrieves the user's community profile from the user profile database 43 according to the IP address in the request, the web analytics server 22 sends the community profile to the advertisement server 34. The above mentioned process is a technical solution that utilizes the user ID, the IP address and cookies to provide targeted advertisement to the users.

The advertisement server 34 examines the received profile and determines the emotional preference according to the information delivered by the web analytics server 22. The advertisement server 34 selects an advertisement according to the retrieved emotional preference and sends the customized advertisement to the user device 28 (step 150).

In one embodiment, the advertisement server 34 monitors the effectiveness of the customized advertisement using the user monitoring system of the present invention. By requesting the user activity data from the user activity monitoring module 93, the advertisement server 34 determines the clickstream of the user after displaying the customized advertisement. The advertisement server determines that whether the advertisement successfully attracts the user to learn more about the product by clicking the advertisement and whether the advertisement successfully attracts the user to become a customer by completing a purchase. The advertisement server 34 analyze the effectiveness of advertisement against users with different emotional profile with a specific primary category, image or tag, and adjust the frequency of display the advertisement to users of that particular type.

Customization of Product Recommendation

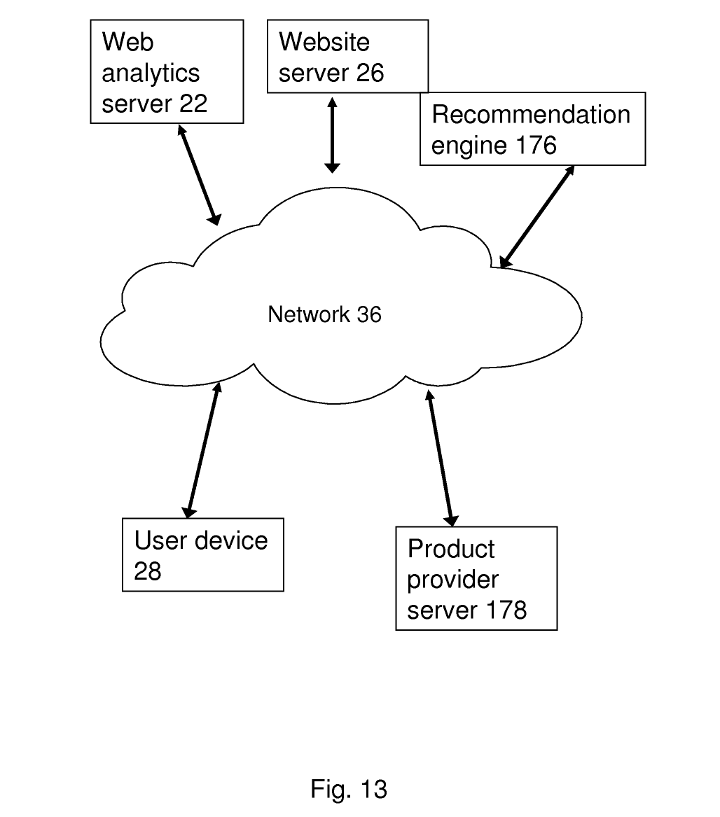

A network diagram of an embodiment of a system for product recommendation using emotional profile is illustrated in FIG. 13. The diagram is similar to that of FIG. 9, however the advertisement server 34 is replaced by a recommendation engine 176, and also a product provider server 178 is provided in this embodiment. In an exemplary embodiment, the product provider server 178 hosts an online database with information of various products. In one embodiment, the recommendation engine 176 is a part of the web analytics server 22.

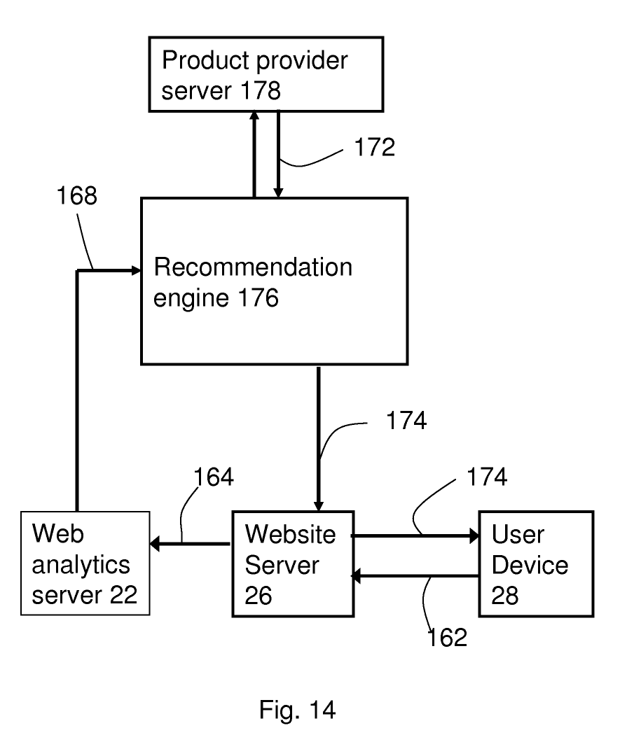

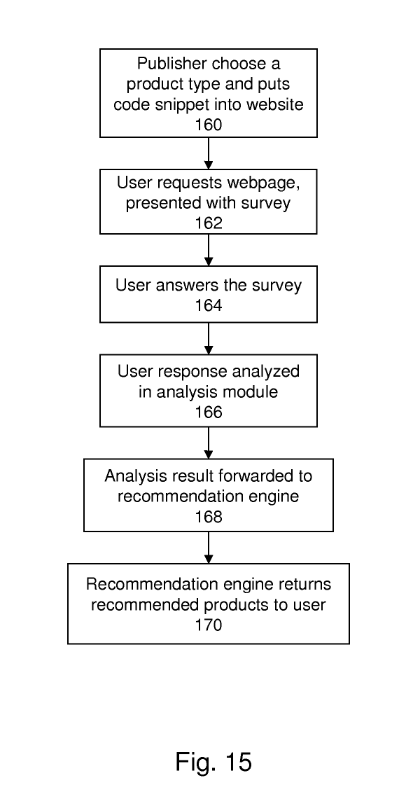

A data flow diagram and a process flow chart of operation of the system are described in FIGS. 14 and 15. As in all applications, the publisher of a website puts a code snippet in the website's web pages. The code snippet links to the web analytics server 22 (step 160). In one embodiment, the publisher needs to specify a shop type which each shop type is associated with at least one product type such that a multimedia survey 60 tailored to the chosen shop type will be presented to the user. The code snippet provided is specific to the chosen shop type. In another embodiment, the code snippet automatically determines the shop type by examining the source code of the webpage. In an exemplary embodiment, the product types include cameras, computers, mobile phones or travel accessories. When the user accesses the website (step 162), he is presented with the multimedia survey 60 for the chosen shop type. After the user answers the survey (step 164), the user response is then analyzed in the analysis module 41 (step 166). The analysis result, which is the emotional code, is forwarded to the recommendation engine 176 for analysis (step 168), as well as recorded in the user profile database 43. The user profile database 43 sends a cookie to the user device 28 as mentioned above.

The recommendation engine 176 returns a list of products or types of products to be recommended to the user (step 170). In one embodiment, the recommended products are a list of items pre-populated according to the user's emotional code from the product provider server 178. In another embodiment, the recommendation engine 176 connects to the product provider server 178 to retrieve the products from the user's emotional code (step 172). The recommended list is then presented to the user through the web browser on the user device 28 (step 174). In yet another embodiment, the publisher of the website can select specific products to be displayed to the user according to the user's emotional code.

In one embodiment, the recommended products are presented to the user as a clickable link. When the user clicks on the link, the link transfers the user to a website that sells the product according to the information on the product provider server 178 so that the user can purchase the product online. Typically, web bugs are present in all the pages such that the web analytics server 22 knows when the user clicks on the link to purchases the product. The web bug does not necessarily need to be sent from the web analytics server 22 as long as the web analytics server 22 can access the data gathered.

As the information for each product can be gathered, statistics for the performance of each product can also be generated. These statistics can be generated for all users or all for users with similar emotional codes or similar demographics such as age and gender. For example, product performance can be tracked by number of clicks on the product, number of purchases of the product or total purchase value of the product. Thus it is possible to tell which type of users like which products more. In one embodiment the publisher can access the data for the products that the publisher selects to be presented to the user. In another embodiment, the products in each product type with top performance, such as most clicked or most purchased, are open for all publishers and users to see.

As described above, the multimedia survey 60 corresponds to a specific shop type. After the user has completed a multimedia survey 60 for a shop type such as mums shop, a visual DNA for the user will be generated. When the user accesses another website that is also supposed to present the user with the mum's survey, the website can read the user's visual DNA generated from the previously answered mums survey from a cookie stored in the user device 28. The recommendation engine 176 will then recommend products to the user based on the previously answered survey result even the user may not have answered a survey on that specific website before. On the other hand, when the user accesses to another website that chose teens shop as the shop type, the user needs to answer a separate survey. In one embodiment, the questions in each survey are totally unique and the same question should not appear in more than one survey. In another embodiment, a question can appear in more than one survey, but if the user has answered that particular question before in a previous survey, that particular question will not show up to the user again. This means the web analytics server 22 stores the information about what questions the user has answered before.

In some cases, a user may elect to ignore the prompt to answer the survey. In one embodiment, the system utilized the website profiling system as described above to tackle this situation. When the user is identified to ignore the survey over a predetermined number of times, the recommendation engine 176 will get the profile of the website stored in the web analytics server 22 and temporarily treats the website profile as the emotional code of the user. The recommendation engine 176 then recommends products to the user based on the website profile. In another embodiment, the recommendation engine 176 will get the user's community profile according the user's IP address, the recommendation engine 176 then recommends products to the user base on the community profile. Once the user answers the multimedia survey 60, the user response will take priority over the website profile in recommendation of products.

In one embodiment, the user response gathered from every survey is stored in the web analytics server 22 and can be applied to all other websites regardless of application. That means even if a website uses the user response to a multimedia survey 60 for one specific application, the user response with other relevant information can be used on other websites for different applications. For example, a user answered a survey on a website that recommends products to the user. The user response to the survey is saved in the web analytics server 22. When the user access another website that delivers customized advertisements to the user, the website can still utilize the data gathered from the previous survey, if the questions previously answered are relevant to the present website.

Implementation in a Specific Embodiment

The following paragraphs describe a specific embodiment of the product recommendation system that also allows the user to purchase products, from the publisher's perspective. The product recommendation system is denoted as “shop” in the following paragraphs. When the publisher accesses to a webpage on the web analytics server for the first time, the publisher needs to choose a shop type for the website on the website server. As an example, the product types include cameras, mobile phones and computers. In another example a “Mums Shop” might have questions in the multimedia survey 60 that determine the age of the user's children and recommend appropriate different products at different ages (prams for babies, toys for toddlers, books for teens). The information of these products is external physical data that can be processed by the present invention. After that, the publisher provides an email address to the webpage. The email address is used for identifying the publisher. A code snippet will then be generated depending on the shop type and the identity of the publisher. The code snippet is shown to the publisher and the publisher needs to put the code snippet into the source code of the publisher's website so that the shop will show up to the users.

When the publisher logs onto the webpage on the web analytics server, the publisher sees a plurality of emotional preference categories defined by the web analytics server. When a certain category is selected, statistics about the users of that category is shown to the publisher. It includes a list of products the recommendation engine recommends for users of that category, what multimedia objects the users of that category are most likely to select or most selected, and the demographic and behavioral profile of the users of that category.

The publisher can also add specific products to the recommended list to be presented to the users. The publisher is first shown a list of products of the product types that are associated with the chosen shop type that is available on the product provider server. The publisher then chooses one or more products to be added to the list. The publisher can also search for specific products to be added that may or may not be in the original list of products shown. After choosing the products to be added, the publisher then needs to assign what types of users should the added products to appear to. The types include but are not limited to emotional preference categories, age, gender or other demographic information. Supplementary description of the emotional preference categories is also available to show the preference of the users in more clear terms.

After some users have accessed the website, the publisher can access the web analytics server to check the statistics regarding the publisher's website for each shop. The statistics include number of “impressions” on the website, customer types based on emotional preference categories, click path about each product and demographic information of the users that visited the website. It can also include a list of top products sold so that the publisher knows what products are most appealing to the users.

This information is useful for publishers in that the publishers can see the overall performance of each product for each user type. Based on this information, the publisher can then further customize the list of recommended products that is more relevant to that user type.

The recommendation engine also makes use of the statistics generated for each product to update and improve the products recommended to each user. For example, if the new product added by a publisher performs well for that user type, the recommendation engine will automatically recommend that product to the users of that user type in other shops. Also, if we learn that users who pick a particular image choice often purchase a particular product we can show that product more often or more prominently to all users who click on a particular image choice. This learning can be done across the entire network of publisher sites, across groups of similar publisher sites or on an individual publisher site.

In a specific example of the multimedia survey, each query and a plurality of multimedia objects among other information is presented to the user. After the user completes the survey, the user is assigned a primary category, and a list of recommended products for that primary category is shown. When the user selects a product, the user is shown with more details of the product, and a link is provided to transfer the user to the product provider server to purchase the product. The user can also go to another website to answer more surveys with a link provided here.

Hardware and Software Implementation

The system block diagram shown in FIG. 1 depicts one embodiment of the present invention. Each of the subsystems can be a data processing system 80 as shown in FIG. 14. This system 80 consists of both the hardware 82 and software components 84 that is used to implement the embodiment of the present invention. The hardware components comprises a Central Processing Unit (CPU) 86, memory 88, storage 81, and multiple interfaces such as the peripheral interface 83, network interface 85, input interface 87 and output interface 89.

CPU 86 can be a single microprocessor or multiple processors combined together. Memory 88 can include read-only memory, random-access memory or other memory technologies, singly or jointly combined. Storage 81 typically includes persistence storage such as magnetic hard disk, floppy disk, optical storage devices such as CD-ROM, and semiconductor storage devices such as flash memory cards, or other storage technologies, singly or in combination. Network interface 85 enables the data processing device 80 to exchange information with the external data communication network such as the Personal Area Network (PAN), the Local Area Network (LAN), the Wide Area Network (WAN), the Internet, and other data communication network architectures, upon which the data communication channel is established. The network interface 85 can include the Ethernet interface, the Wireless LAN interface device, the Bluetooth interfacing device and other networking devices, singly or in combination.

Software 84 includes the operating system 91, and one or more software implementations of those systems as shown in FIG. 1.

It should be understood for those skilled in the art that the division between hardware and software is a conceptual division for ease of understanding and is somewhat arbitrary. Furthermore, the application software systems may be executed in a distributed computing environment. The software program and its related databases can be stored in a separate file server or database server and are transferred to the local host for execution. The data processing device 80 as shown in FIG. 8 is therefore an exemplary embodiment of how it can be implemented. Those skilled in the art will appreciate that alternative embodiments can be adopted to implement the present invention.

Also, the website server 26 is only used as an example in the method described above. Other than website servers, mobile sites, on-demand television, and other similar platforms all fall under the scope of this invention.

It is described above that the advertisement server 34 analyzes the effectiveness of advertisements to users of a specific primary category and adjusts the frequency of displaying the advertisements to the user. It is equally applicable to the recommendation engine 176 in the application of product recommendation.

What is claimed is:

1. A method of delivering customized content to a user, comprising:
assigning an emotional preference to content on a website server,
obtaining said emotional preference of said user from a web analytics server;
customizing content on said website server by
comparing said emotional preference of said user with said emotional preference of said content against a predetermined criterion;
retrieving contents that satisfy said predetermined criterion in said website as customized content; and
presenting said customized content to said user through a user device;
whereby said content is enhanced to be more relevant to said user.

2. The method of claim 1, wherein said emotional preference of said user is obtained through a cookie stored in said user device, said cookie refers to an emotional preference database of said web analytics server to obtain said emotional preference of said user.

3. The method of claim 1, further comprising a step of generating an emotional preference to said user, said generating step comprises the steps of:
presenting a multimedia survey through a code snippet at said user device to said user, said multimedia survey comprises at least one query, each query comprises a set of multimedia objects in which said user selects said object as a response;
gathering through said code snippet said user's response to each query and forwarding to said web analytics server;
analyzing said user response in an analyzing module of said web analytics server; and
designating said emotional preference to said user based on results of said analyzing step.

4. The method of claim 3, wherein said analyzing step comprises the steps of:
assigning a score for each multimedia object to a plurality of categories;
extracting said scores for each category for said multimedia objects that said user selects;
tallying said scores for each category.

5. The method of claim 3, wherein said analyzing step comprises the steps of:
defining at least two axes for each query;
assigning a score for each axis to each multimedia object to said query;
assigning a score for each axis to each of a plurality of categories for each query;
calculating a mathematical distance between said scores of said user response and said scores of each of said categories for each query; and
aggregating said mathematical distance in each query for each category.

6. The method of claim 5, wherein said designating step assigns a combination of said aggregated mathematical distance for each category as said user's emotional code, said category with shortest said aggregated mathematical distance as said user's primary category.

7. The method of claim 3, wherein said analyzing step comprises the steps of:
assigning at least one keyword and a score associated with each said keyword for each multimedia object in each query;
extracting said at least one keyword and said score for said multimedia objects that said user selects;
calculating the sum of said scores for each said keyword.

8. The method of claim 1, wherein said obtaining step further comprises the steps of:
defining a user community that shares at least one characteristic with said user;
designating a community emotional preference to said user community by:
retrieving said emotional preferences of those users that possess emotional preference within said user community;
analyzing said retrieved emotional preferences; and determining said community emotional preference; and
allocating said community emotional preference to said user, wherein said user belongs to said community and do not possess an emotional preference.

9. The method of claim 8, wherein said analyzing step tallies up said retrieved emotional preferences and returns an emotional preference with the most counts among said retrieved emotional preferences as said community emotional preference.

10. The method of claim 8, wherein said community emotional preference assigned to said user is replaced when said user completes a multimedia survey and an emotional preference is generated from said user's answer to said survey.

11. The method of claim 1, wherein said emotional preference includes content of a plurality of multimedia objects said user selects in at least one multimedia survey.

12. The method of claim 1, wherein said emotional preference includes at least one tag associated with a plurality of multimedia objects said user selects in at least one multimedia survey.

13. The method of claim 1, wherein said customized content is advertisement and said website server is an advertisement server.

14. The method of claim 1, wherein said customized content is recommendation of products, the method further comprising the steps of:
recommending a list of products in a recommendation engine based on said user's emotional preference, said recommended products are available to be purchased online in at least one product provider server;
presenting said recommended products to said user on said user device, wherein each said recommended product is presented in a way such that enables said user to purchase said recommended product online.

15. The method of claim 14, wherein said emotional preference of said user is used for recommendation of a type of products.

16. The method of claim 14, wherein said recommendation engine further adjusts a frequency of presenting said recommended products based on said user's emotional preference.

17. A system of delivering customized content to a user, comprising:
a web analytics server, said web analytics server stores an emotional preference of said user;
a website server, said website server connected to said web analytics server through a network; and
a user device, said user device connected to said website server through said network;
wherein said website server retrieves said emotional preference of said user from said web analytics server, customizes content on said website server by comparing said emotional preference of said user with said emotional preference of said content against a predetermined criterion and retrieving contents that satisfy said predetermined criterion in said website as customized content, and presents said customized content to said user through a user device.

18. The system of claim 17, further comprising an advertisement server, wherein said customized content is advertisement, and said website server retrieves customized advertisement from said advertisement server and delivers said customized advertisement to said user.

19. The system of claim 17, further comprising a product provider server, and said web analytics server comprises a recommendation engine that recommends a list of products based on said user's emotional preference and delivers said list of products to said user, each product on said list of products is purchasable online on said product provider server.

20. The system of claim 17, wherein said web analytics server comprises:
an emotional profiling module that generates said user's emotional preference;
a user activity monitoring module that monitors said user's activities on said website server;
an analysis module that analyzes user response; and
a website profiling module that gathers information from a plurality of users from said emotional profiling module and said user activity monitoring module, and generates statistics for a user community within said plurality of users based on at least one criterion.
